(19) United States
(12) Patent Application Publication
(10) Pub. No.: US 2003/0126890 A1
(43) Pub. Date: Jul. 10, 2003

(54) Optical fiber drawing method

(75) Inventors: Nobuaki Orita, Tokyo (JP); Shinpei Todo, Tokyo (JP); Yasuhiro Naka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/269,053

(22) Filed: Oct. 11, 2002

(30) Foreign Application Priority Data
Oct. 12, 2001 (JP) 2001-316099

(51) Int. Cl. C03C 25/24

(52) U.S. Cl. 65/432

(57) ABSTRACT

A method for fiber drawing of an optical fiber, which method comprises:

using a drawing apparatus in which the distance between an outlet of a drawing furnace for heat-drawing from an optical fiber preform and a capstan or pulley where an optical fiber drawn vertically downwards changes its direction toward a take-up device is not less than 14 m;

providing, between the outlet of the drawing furnace and an optical fiber cooler arranged below the outlet, a natural cooling space of not less than 1.5 m in which no forced gas flow is generated around the optical fiber, to allow the optical fiber to be cooled naturally;

cooling the optical fiber by the optical fiber cooler; and

coating the optical fiber with a resin.

### FIELD

The present invention relates to an optical fiber drawing method.

### BACKGROUND

FIG. 5 shows a drawing apparatus generally used in the conventional optical fiber drawing method. An optical fiber preform 1 is inserted into a muffle tube 5 of a drawing furnace 3 equipped with a heater 4, and the forward end portion of the optical fiber preform 1 is heated and softened at 1900 to 2200° C. An optical fiber 2 obtained through drawing is extracted from the drawing furnace 3, and then its outer diameter is measured by an outer-diameter measurement device 7. After the optical fiber 2 has been cooled with an optical fiber cooler 8 to a temperature which allows coating, a resin is applied to the outer periphery of the optical fiber 2 with a coating device 9. The resin is cured by a resin-curing device 10, and the optical fiber 2 is fed by means of a capstan or pulley 11 to be taken up on a bobbin by a take-up device 12.

As shown, for example, in FIG. 6, a helium cooler in which helium gas having high heat transfer coefficient flows around the optical fiber 2 is used as the optical fiber cooler 8. A cooling cylinder 15 through which the optical fiber 2 is passed is equipped with a supply port and an exhaust port for cooling gas, the helium gas flowing through this cylinder. The optical fiber cooler 8 has a jacketed structure, and cooling water flows in the jacket.

As a result of the recent increase in the demand for optical fibers, drawing has come to be performed at a high speed of not lower than 20 m/sec using a large-sized optical fiber preform in order to mass-produce the optical fiber with a lower cost. Such a high-speed optical fiber drawing requires a sufficient fiber cooling length of not less than 6 m, so that a drawing apparatus is generally used in which the distance between the outlet of the drawing furnace and the capstan or pulley, where the optical fiber drawn vertically downwards changes its direction toward the take-up device, is not less than 14 m.

When the optical fiber leaving the drawing furnace is exposed for a long period of time to the atmosphere containing much dust, dust or the like is allowed to adhere to the fiber, resulting in a deterioration in the mechanical strength and transmission property of the optical fiber. Thus, in high-speed drawing, it is necessary to effectively utilize the height of the drawing apparatus for fiber cooling. In view of this, the space between the drawing furnace and the optical fiber cooler is made as short as possible (that is, the length of the cooler is increased), or the space between the drawing furnace and the optical fiber cooler is surrounded by a box or the like, with clean air flowing therethrough.

However, it is to be noted that in high-speed drawing operation, a fine vibration occurs in the fiber. If the cooling length is increased and an optical fiber cooler like a helium cooling cylinder is provided between the drawing furnace and the coating device, with helium gas for cooling flowing therethrough, the vibration (amplitude) of the fiber is increased. Further, a vibration is likely to occur also in the optical fiber preform, which causes undesirable problems. When the vibration of the fiber preform is magnified, fluctuation is generated in the atmosphere temperature around the fiber curing point, and the fiber curing position becomes unstable, resulting in an increase in fiber diameter fluctuation. Further, as has been found out, the residual distortion at the time of fiber curing also increases, resulting in an increase in transmission loss. Further, breakage of the fiber sometimes occurs, making it necessary to temporarily halt the operation. In particular, the above problems become prominent when drawing a large-sized optical fiber preform as shown in FIG. 2, which has a diameter of not less than 100 mm, a parallel portion length of not less than 1200 mm, and a total length of not less than 2000 mm inclusive the length of the support bar.

### SUMMARY

The present invention is a method for fiber drawing of an optical fiber, which method comprises:

using a drawing apparatus in which the distance between an outlet of a drawing furnace for heat-drawing from an optical fiber preform and a capstan or pulley where an optical fiber drawn vertically downwards changes its direction toward a take-up device is not less than 14 m;

providing, between the outlet of the drawing furnace and an optical fiber cooler arranged below the outlet, a natural cooling space of not less than 1.5 m in which no forced gas flow is generated around the optical fiber, to allow the optical fiber to be cooled naturally;

cooling the optical fiber by the optical fiber cooler; and

coating the optical fiber with a resin.

Other and further features and advantages of the invention will appear more fully from the following description, taken in connection with the accompanying drawings.

### BRIEF DESCRIPTION OF THE DRAWINGS

FIG. 1 is a schematic diagram showing an example of a drawing apparatus to be used in the method of the present invention.

FIG. 2 is an explanatory diagram showing an optical fiber preform that is used in the examples described below.

FIG. 3 is a graph showing the relationship between optical fiber cooler length and fiber vibration (amplitude).

FIG. 4 is a graph showing the relationship between drawing time and fiber vibration (amplitude).

FIG. 5 is a schematic diagram showing a conventional drawing apparatus.

FIG. 6 is a schematic diagram showing an optical fiber cooler.

### DETAILED DESCRIPTION

According to the present invention, there is provided the following means:

(1) A method for fiber drawing of an optical fiber, which method comprises:

using a drawing apparatus in which the distance between an outlet of a drawing furnace for heat-drawing from an optical fiber preform and a capstan or pulley where an optical fiber drawn vertically downwards changes its direction toward a take-up device is not less than 14 m;

providing, between the outlet of the drawing furnace and an optical fiber cooler arranged below the outlet, a natural cooling space of not less than 1.5 m in which no forced gas flow is generated around the optical fiber, to allow the optical fiber to be cooled naturally;

cooling the optical fiber by the optical fiber cooler; and

coating the optical fiber with a resin;

(2) The method according to the above item (1), wherein a diameter of the optical fiber preform is not less than 100 mm; and

(3) The method according to the above item (1) or (2), wherein a drawing rate is not lower than 20 m/sec.

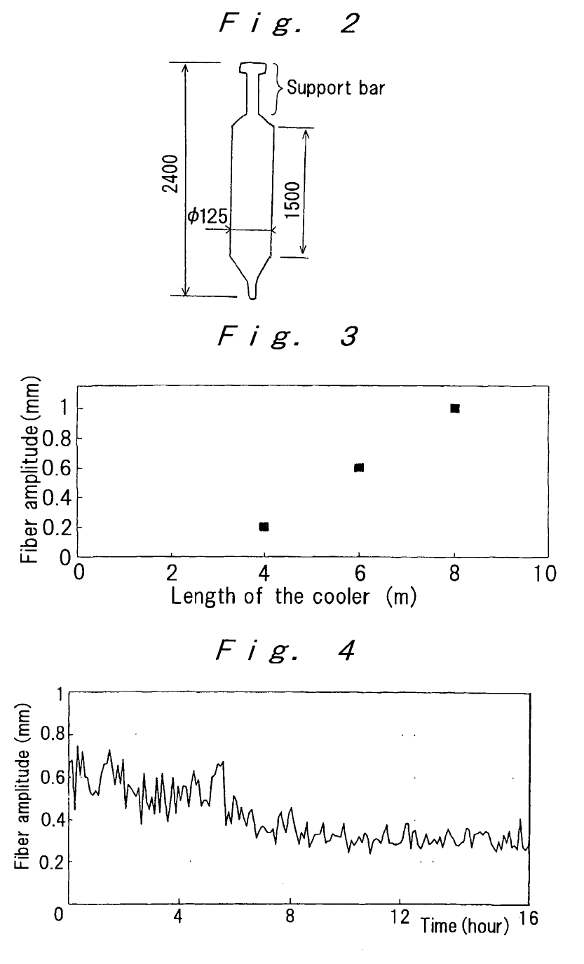

The present inventors have studied keenly, to solve the problems accompanied by the conventional method mentioned above. As a result, the present inventors have examined the relationship between the length of an optical fiber cooler (cooling helium flow rate: 20 slm) and the fiber vibration (amplitude) when drawing is performed on an optical fiber preform (shown in FIG. 2) having a diameter of 125 mm and a parallel portion length of 1500 mm (a total length of 2400 mm) at a rate of 20 m/sec, to obtain the result as shown in FIG. 3. Under the same conditions, the present inventors have examined the relationship between the drawing time and the fiber vibration (amplitude), to obtain the result as shown in FIG. 4. From these results, it can be seen that the longer the optical fiber cooler is, and the earlier it is in the drawing operation, the greater the fiber vibration is. Herein, the fiber amplitude is obtained by detecting the fiber position by means of the laser outer-diameter measurement device provided directly below the drawing furnace, to determine the amplitude of the fiber.

Further, on the basis of these relationships and the degree of cooling of the fiber, we have confirmed that the problems due to the conventional method mentioned above can be solved by conducting forced cooling after natural cooling, thereby completing the present invention.

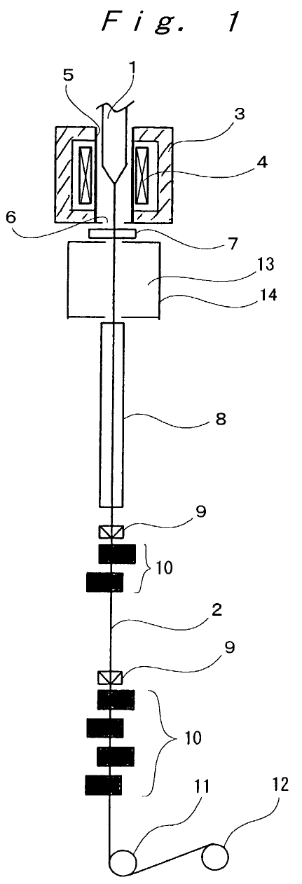

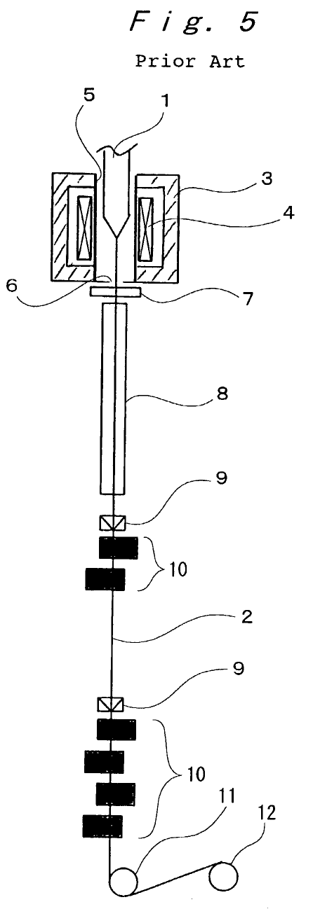

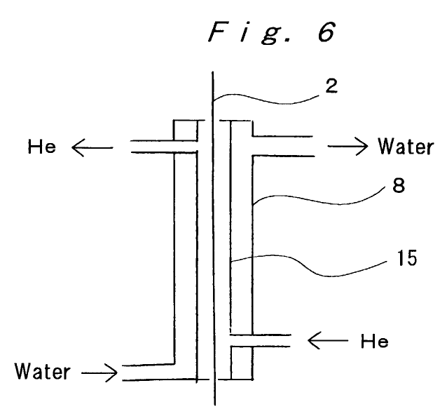

A preferred embodiment of the optical fiber drawing method of the present invention will be described in detail with reference to FIGS. 1 and 2. FIG. 1 is a schematic diagram for illustrating an example of a drawing apparatus to be used in the optical fiber drawing method of the present invention. The components which are the same as those of FIGS. 5 and 6 are indicated by the same reference numerals.

FIG. 1 shows a high-speed drawing apparatus in which the distance between an outlet 6 of a drawing furnace 3 and a capstan or pulley 11 is approximately 14 m to 20 m.

The apparatus uses a large-sized optical fiber preform (1), as shown in FIG. 2. The optical fiber preform 1 preferably has a diameter of 100 mm to 350 mm and a parallel portion length of 1500 mm to 2000 mm. The diameter is more preferably 100 mm to 150 mm. The optical fiber preform 1 is suspended and inserted into a muffle tube 5 of the drawing furnace 3 equipped with a heater 4, and its forward end portion is heated and softened at 1900° C. to 2200° C. for drawing. It is preferable that the drawing be conducted at a rate of 20 m/sec to 60 m/sec, more preferably 20 m/sec to 30 m/sec.

It is necessary for an optical fiber 2 obtained through drawing to be cooled to a temperature which allows resin coating and which ranges from approximately 50° C. to room temperature, depending upon the resin to be used for coating. The optical fiber 2 is passed through a natural cooling space 13 and a well-known optical fiber cooler 8 for forced cooling as shown in FIG. 6. The optical fiber 2 allows to be cooled naturally between the outlet 6 of the drawing furnace and the optical fiber cooler 8. Herein, the term “natural cooling” means that the optical fiber 2 is cooled by natural convection of a gas in a space in which no forced gas flow is generated around the optical fiber 2. It is necessary for the space for natural cooling to have a length of not less than 1.5 m in the fiber running direction. Preferably, it is a space of a length of 2 to 4 m. If the length of this space is less than 1.5 m, the optical fiber cooler (8) for forced cooling has to be rather long, making it impossible to attain the effect of preventing vibration. On the other hand, a too short length of the optical fiber cooler (8) results in the fiber being exposed to the atmosphere, which means there arises an anxiety of dust adhesion or the like.

It is preferable that this natural cooling space be formed in a box 14 of an appropriate configuration. A clean gas at approximately room temperature, such as clean air or nitrogen gas, is introduced into the box through a side surface thereof, which may have at least one inlet for gases, and a baffle board is provided at the inlet as needed. The gas introduced flows out through the upper and lower openings for passing the fiber or through an exhaust port provided in a side surface as needed, thus preventing generation of a forced gas flow causing vibration around the fiber. The gas introduction amount is approximately 1.5 m³/min to 2 m³/min.

For the forced cooling of the optical fiber 2, helium, which has large heat transfer coefficient, can be used. In addition thereto, it is possible to use nitrogen, argon or the like in combination with helium. The supply amount of the gas is controlled based on the coating diameter, drawing rate, and the like. From the viewpoint of preventing vibration of the fiber, the supply amount is preferably 30 liter/min or less. From the viewpoint of preventing vibration of the fiber, the length of the optical fiber cooler 8 is preferably 4 to 6 m.

The diameter of the optical fiber (2) obtained through drawing is measured by the outer-diameter measurement device 7 provided below the drawing furnace and using a laser. Then, the drawing condition is monitored, and the cooling gas amount is controlled; at the same time, the fiber position is also detected to determine the fiber vibration (amplitude) as needed.

As mentioned above, the optical fiber that has undergone natural cooling and forced cooling is cooled to a sufficiently low temperature. The vibration (amplitude) at the time of drawing is generally 0.3 mm to 0.7 mm, which is approximately the same as that in the case of drawing operation at medium speed. The fluctuation in the fiber diameter is generally within a range of ±0.3 μm, which is satisfactory.

The outer peripheral surface of the cooled optical fiber 2 is coated with a resin to a predetermined thickness with a coating device 9, and the resin is dried and cured by a resin-curing device 10. When a coating in two or more layers is required, resin coating is effected after cooling by the cooler, and the resin is dried and cured. Thereafter, the resulting optical fiber (2) is taken up on a bobbin by a take-up device 12 by way of the capstan or pulley 11.

The transmission loss of the optical fiber 2 thus obtained was measured. As in the example described below, the value of transmission loss in accordance with the present invention is not more than 0.190 dB/km at 1.55 μm, which is satisfactory.

According to the method of the present invention, although optical fiber drawing is effected at high speed using a large-sized optical fiber preform, it is possible to restrain fiber vibration and generation of preform vibration attributable thereto, and the problems such as breakage of the fiber are little involved. Further, the fluctuation in the diameter of the fiber to be obtained is generally within the range of ±0.3 μm, which is to be regarded as stable; its transmission loss is as small as not more than 0.190 dB/km at 1.55 μm, thus making it possible to perform drawing to give a high-quality optical fiber, in a stable manner.

Further, according to the method of the present invention, when a large-sized optical fiber preform is drawn at a high speed, there can be obtained an optical fiber having a constant fiber diameter and little transmission loss, by performing the above fiber-drawing that is quite small in fiber vibration (amplitude) in a stable state to stabilize a fiber curing position.

### EXAMPLES

In the following, the present invention will be described in more detail with reference to specific examples, which should not be construed restrictively to these; various modifications are possible without departing from the scope of the invention as defined by the accompanying claims.

### Example 1

Optical fiber drawing was conducted in accordance with the present invention by using the drawing apparatus shown in FIG. 1. In the drawing apparatus used, the length as measured between the outlet 6 of the drawing furnace 3 and the capstan 11 was 18 m, and a space of over 3 m was provided below the drawing furnace 3, and the coating device 9 and the resin-curing device 10 were provided below the optical fiber cooler 8 having its length of 6 m for forced cooling using helium. The space between the outer-diameter measurement device 7 and the optical fiber cooler 8 was surrounded by a box 14 so as to define a natural cooling space 13 of a length of 3 m, and clean air at room temperature was introduced into the box 14; a baffle board was provided at the inlet for clean air to prevent generation of a forced gas flow around the fiber.

Using such a drawing apparatus, drawing was performed, by using the optical fiber preform 1 as shown in FIG. 2 having a diameter of 125 mm and a parallel portion length of 1500 mm (a total length of 2400 mm), with a drawing tension of 75 gf and at a drawing rate of 20 m/sec. At this time, the flow rate of helium gas for cooling the fiber was 15 liter/min, and the fiber vibration (amplitude) under the drawing furnace 3 was 0.6 mm at the maximum. The fluctuation in fiber diameter was in a satisfactory range of ±0.2 μm, and transmission loss of the optical fiber obtained was 0.189 dB/km at 1.55 μm.

At a drawing rate of 25 m/sec, the flow rate of helium gas for cooling the fiber was 25 liter/min; the fiber vibration (amplitude) under the drawing furnace 3 was as large as 0.7 mm at the maximum, and the fluctuation in fiber diameter was ±0.2 μm, which was satisfactory. The transmission loss of the optical fiber obtained was 0.190 dB/km at 1.55 μm.

### Example 2

In a drawing method of Example 1, a drawing apparatus was used in which the length between the outlet 6 of the drawing furnace and the pulley 11 was 14 m; a space of over 1.5 m was provided below the drawing furnace 3, and the coating device 9 and the resin-curing device 10 were provided below the optical fiber cooler 8 having its length of 6 m. The space between the outer-diameter measurement device 7 and the optical fiber cooler 8 was surrounded by a box 14 so as to define a natural cooling space 13 of a length of 1.5 m, and clean air at room temperature was introduced into the box 14; a baffle board was provided at the inlet for clean air, preventing generation of a forced gas flow around the fiber.

Using such a drawing apparatus, drawing was performed on the optical fiber preform 1 having, like that in Example 1, a diameter of 125 mm, at a drawing rate of 20 m/sec. At this time, the flow rate of helium gas for cooling the fiber was 25 liter/min, and the fiber vibration (amplitude) under the drawing furnace 3 was 0.6 mm at the maximum. The fluctuation in fiber diameter was in a satisfactory range of ±0.2 μm, and the transmission loss of the optical fiber obtained was 0.190 dB/km at 1.55 μm.

### Comparative Example 1

Using the drawing apparatus of Example 1, wherein a natural cooling space 13 of 1 m was provided below the drawing furnace 3, and an optical fiber cooler 8 having its length of 8 m was installed; drawing was performed on an optical fiber preform 1 with a diameter of 125 mm similar to that of Example 1. Apart from the above, this comparative example was the same as Example 1.

At a drawing rate of 20 m/sec, the flow rate of helium gas for cooling the fiber was 8 liter/min; the fiber vibration (amplitude) under the furnace 3 was as large as 1.0 mm at the maximum, and the fluctuation in fiber diameter was +0.4 μm. The transmission loss of the optical fiber obtained was 0.193 dB/km at 1.55 μm.

### Comparative Example 2

Using the drawing apparatus of Example 2, wherein a natural cooling space 13 of 0.5 m was provided below the drawing furnace 3, and an optical fiber cooler 8 having its length of 7 m was installed; drawing was performed on an optical fiber preform 1 with a diameter of 125 mm similar to that of Example 2. Apart from the above, this comparative example was the same as Example 2.

At a drawing rate of 20 m/sec, the flow rate of helium gas for cooling the fiber was 15 liter/min; the fiber vibration (amplitude) under the drawing furnace 3 was as large as 0.8 mm at the maximum, and the fluctuation in fiber diameter was ±0.4 μm. The transmission loss of the optical fiber obtained was 0.194 dB/km at 1.55 μm.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A method for fiber drawing of an optical fiber, which method comprises:
using a drawing apparatus in which the distance between an outlet of a drawing furnace for heat-drawing from an optical fiber preform and a capstan or pulley where an optical fiber drawn vertically downwards changes its direction toward a take-up device is not less than 14 m;
providing, between the outlet of the drawing furnace and an optical fiber cooler arranged below the outlet, a natural cooling space of not less than 1.5 m in which no forced gas flow is generated around the optical fiber, to allow the optical fiber to be cooled naturally;
cooling the optical fiber by the optical fiber cooler; and
coating the optical fiber with a resin.

2. The method according to claim 1, wherein a diameter of the optical fiber preform is not less than 100 mm.

3. The method according to claim 2, wherein a drawing rate is not lower than 20 m/sec.

4. The method according to claim 1, wherein a drawing rate is not lower than 20 m/sec.

5. The method according to claim 1, wherein the natural cooling space has a length of 2 to 4 m.

6. The method according to claim 1, wherein the natural cooling space is formed in a box having, on a side surface of the box, at least one inlet for gas, and a baffle board is provided at the inlet.

7. The method according to claim 1, wherein the optical fiber preform has a diameter of 100 mm to 350 mm.

8. The method according to claim 1, wherein a drawing rate is 20 m/sec to 60 m/sec.
